(19) United States
(12) Patent Application Publication
(10) Pub. No.: US 2008/0043991 A1
(43) Pub. Date: Feb. 21, 2008

(54) Instrument uses augmented keypad for text entry

(76) Inventor: Kenneth D. Poulton, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/495,041

(22) Filed: Jul. 28, 2006

(51) Int. Cl. H04M 1/00; H04M 3/00

(52) U.S. Cl. 379/368

(57) ABSTRACT

An instrument, analyzer or item of test equipment for some technical discipline is equipped with a numeric keypad that, in addition to the digits zero through nine and the decimal point, and which instead of carrying all the keys ordinarily needed, has been augmented to carry additional sequences of ordered symbols or legends. The multi-tap and T9Word techniques may be used to enter text strings that may include technical legends and abbreviations. In a system where another row or column of keys has been added, a CMD (‘COMMAND’) key can institute a Symbol Mode where selected keys, including the digit keys exhibit multi-tap or T9Word operation, whereas they ordinarily do not, so as to be able to support rapid numeric entry of arbitrary sequences of digits, including consecutively repeated digits. The Symbol Mode may be automatically entered and exited during the execution of commands or operations that need Symbol Mode input.

### INTRODUCTION AND BACKGROUND

The evolution of the microprocessor into a family of standardized and affordable system components has helped work a revolution in the nature of most electronic test equipment, as well as for other items that are electronically implemented ‘instruments’ associated with some discipline. The ‘digital revolution’ has meant not only that analog signals that used to be measured or characterized by ‘viewing them end on’ and using signal flow in a ‘continuous path’ of analog circuitry to transform the applied input into a suitable output are now instead digitized for a suitable length of time, the values stored in a memory and then used to ‘view the signal from the side’ by an algorithm that computes the needed result(s). Similar developments have occurred for apparatus that could be considered a ‘source’ instead of a measurement or analysis device. It has also meant that mode switches and controls that used to be separate physical items on the front panel are now implemented as commands to be interpreted by an embedded system within the test equipment and the associated algorithmic processes. Furthermore, the penalties in terms of instrument size, weight, panel space required, power consumption, and manufacturing cost for adding operational features (think: more complicated algorithms) are small compared to the perceived benefits.

In some cases the front panel includes a display device, such as an LCD (Liquid Crystal Display) panel, and an array of special purpose keys, or push buttons. Panel space, ergonomic and esthetic considerations limit the number of keys, and keys often have several labels (e.g., words, abbreviations of phrases, etc.) printed in different colors; the color in effect is context sensitive, and is usually determined by previous activation of a ‘shift’ key of a corresponding color. A small array of numeric keys sometimes accompanies the array of ‘feature keys.’ Other times the digit, sign and arithmetic keys are simply shifted meanings on the main collection of ‘feature keys.’ We might call this arrangement a ‘key per function’ type of solution.

The cost of the digital processing components, such as the microprocessor and memory, needed to implement an embedded control and measurement system for an item of test equipment has decreased considerably, while in many cases the number of features has increased. Some instruments either have, or accept as a plug-in accessory, a complete alpha-numeric keyboard (they, too, have become standardized). In such equipment only a few special keys of dedicated purpose might remain on the front panel, and many of the instrument's more powerful (and ‘user friendly’) features make use of the ability to key in strings of symbols parsed into various commands, parameters, labels and comments. Sometimes such instruments even appear to be programmable, in the true sense of the word. We might call this arrangement a ‘parsed string’ type of solution.

It can happen that an item of test equipment can support or implement features that require more keys than the desired size of the instrument will allow. This might happen because a desire to keep cost low, or because of an urge to ‘make the thing fit in a shirt pocket.’ It might also happen if, except for the size the size of full function keyboard, the item of test equipment would be considerably smaller. The control scheme might be either a key per function or a parsed string arrangement. In either case the designer lacks, or prefers not to provide or expend, the panel space for a sufficient number of comfortably sized keys. Progress in the art of creating VLSI (Very Large Scale Integration) parts has essentially solved many of the problems about what is to go inside the instrument, but that has done nothing about the size of the blunt instrument known as the human fingertip. Granted, one could use an array of tiny keys to be poked on with a stylus (computing watches, such as the old HP 01 come to mind), but now the lettering is so small that only perfect vision or an up to date prescription for glasses (assuming they are handy, and not misplaced or forgotten) allows the user to operate the ‘keyboard.’

In a more practical vein, either of the two text entry schemes used with telephone keypads may be used to accomplish the entry of symbols or strings of symbols that are not numeric parameters with a reduced keypad having separate keys for digits and certain other things. Assuming a Text Entry Mode is in effect and that the ‘2’ key also carries the indicia ‘ABC’, then in a “multi-tap” technique a single tap or pressing of the ‘2’ key will enter ‘A’, a second such action within a limited time a ‘B’, and a third ‘C’.

Another system, known as “T9Word,” produces entries from a dictionary when the user presses a key just once each for each next letter of the desired word that is carried by the key. (That is, it recognizes potential partial spellings in combination with ‘steering mechanisms’ to peruse choices and select one for use with further keystrokes. The ‘steering mechanisms’ are alternate meanings for some otherwise seldom used keys. T9Word, in its full glory can be intimidating and frustrating for the uninitiated. The written instructions about how to get ‘fog’ instead of ‘dog’ would likely run to several paragraphs, and while the scheme has a consistent internal logic, there are also ancillary issues about how to add to and edit the dictionary. All in all, whatever it is, T9Word is NOT intuitive, and it seems probable that few who have tried it are ambivalent about it—they either love it or they hate it.)

While both the multi-tap and T9Word techniques are in common use with reduced keypads, and each does offer a suitable starting place for text and command entry for a “small” instrument (e.g., an item of test equipment for some discipline, whether electronic, biological, mechanical or optical, etc.), neither as currently implemented is a completely appropriate solution for the various issues that arise during frequent and rapid entry of measurement related text (keyed symbols and legends), many of which are apt to belong to a technical vocabulary. Using a ‘small’ instrument to make a series of related measurements involving extensive use of keyed symbols and legends is noticeably different from fumbling around to get Charlie's name, address and two phone numbers into a cell phone's contact list that only gets a new entry maybe once a month. We seek an elegant, or at least graceful, solution for rapid, easy and efficient entry of a specialized vocabulary of text that may include commands, parameters and labels, and also technical symbols and legends for measurements, their units, related arithmetic and other computation that is befitting a sophisticated, albeit probably small, piece of electronically implemented instrument or item of test equipment. What to do?

### Simplified Description

A solution to the problem of insufficient space, on a front panel of an instrument or on an item of test equipment, for all the separate individual keys otherwise needed is to equip the instrument or item with a numeric keypad that has, beyond the digits zero through nine and the decimal point, been augmented to carry additional sequences of ordered symbols or legends. The usual twelve button keypad found on touch tone or cellular telephones is but an exemplary starting point, as it may be desirable to add another row or another column of keys. In any event, while the exact layout of the keypad will likely be chosen to suit the application, either of the two text entry schemes known as multi-tap or T9Word and used with telephone keypads may still be used to accomplish the entry of simple text (symbols or strings of symbols that are not numeric parameters).

Advantages of the telephone keypads are that these techniques are familiar, there are merchant instances in commerce of such keypads that are low cost standard parts that are well supported by other components, and these keypads are generally small. However, if additional ‘text symbols’ were required, different keypads can be provided where each key carries more than the ususal three additional meanings, just as the ‘7’ key now carries ‘PQRS’ and ‘9’ carries ‘WXYZ’. If ‘1’ carried ‘ABCD’ and ‘2’ carried ‘EFGH’ several additional digit keys would be available for more text symbols. In a system where another row or column of keys has been added, a CMD (“COMMAND”) key can institute a Symbol Mode where selected keys, including the digit keys, exhibit multi-tap operation (which in a Numeric Mode they do not, so as to be able to support the unconstrained numeric entry of arbitrary sequences of digits, including consecutively repeated digits). In the Symbol Mode the digit symbols on the digit keys are themselves treated as text, subject to the multi-tap or T9Word technique. The Symbol Mode can be entered, used and exited automatically as part of the fulfilment of a command being executed or performed.

### BRIEF DESCRIPTION OF THE DRAWINGS

FIG. 1 is a front view of a typical prior art telephone keypad of the touch tone variety;

FIG. 2 is a front view of a typical prior art keypad for a cellular telephone;

FIG. 3 is a simplified representative view of a typical prior art keyboard that might be found on an electronic measurement instrument, but which does not permit text entry;

FIG. 4 is a view of a first augmented numeric keypad that allows text entry for a small electronically implemented measurement instrument, and which does permit text entry;

FIG. 5 is a view of a second augmented keypad that allows text entry for a small electronically implemented measurement instrument, and which does permit text entry;

FIG. 6 is a simplified front view of a fanciful item of electronic test equipment whose limited front panel carries the augmented numeric keypad of FIG. 4 to permit text entry;

FIG. 7 is a simplified front view of a fanciful item of electronic test equipment similar to that shown in FIG. 6;

FIG. 8 is a simplified front view of a fanciful item of electronic test equipment whose limited front panel carries the augmented numeric keypad of FIG. 5 to permit text entry; and

FIG. 9 is a simplified front view of a fanciful item of electronic test equipment whose limited front panel carries an augmented numeric keypad that is a hybrid of FIGS. 1 and 4 to permit text entry.

### DETAILED DESCRIPTION

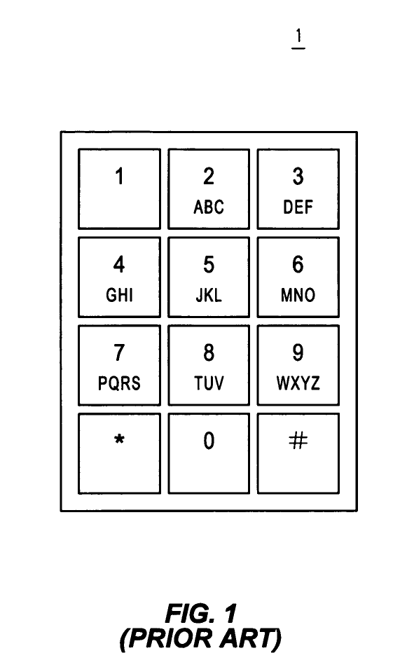

Refer now to FIG. 1, wherein is shown a front view of a typical prior art touch tone keypad 1 for a wireline telephone, or a wireless handset for a wired base station. This keypad is sometimes used for text entry over the phone: existing stock-quote systems will perform text entry operations by construing pairs of digits (N1, N2) as (which key, which supplementary symbol on that key). Since only keys ‘2’ through ‘9’ have supplementary symbols, N1 is limited to the digits ‘2’ through ‘9’, while N2 is limited to ‘1’ through ‘4’, as there are at most four supplementary symbols on any of the keys.

Assuming a text entry mode is in effect and that the ‘2’ key also carries the indicia ‘ABC’, then in a “multi-tap” technique a single tap or pressing of the ‘2’ key will enter ‘A’, a second such action within a limited time a ‘B’, and a third ‘C’. A fourth consecutive keystroke would enter a ‘2’. The notion of ‘consecutive’ is delimited by time, so that an entry of ‘CC’ requires a deliberate pause after the third keystroke (producing the first ‘C’), after which the next keystroke is now construed as a ‘first’ keystroke and not as a ‘fourth’ one.

Another system, known as “T9Word,” produces entries from a dictionary when the user presses a key just once each for each next letter of the desired word that is carried by the key. (That is, it recognizes potential partial spellings in combination with ‘steering mechanisms’ to peruse choices and select one for use with further keystrokes. The ‘steering mechanisms’ are alternate meanings for some seldom used keys.)

Advantages of the touch tone keypad 1 and these techniques are that they are familiar, the keypad is a low cost standard part that is well supported by other components, and the keypad 1 is generally small. These schemes are good for simple text, but do not do so well for arbitrary text, especially of the sort that might be used as parsed commands in a technical environment. Those applications need strings that are more complicated, in that they require punctuation, symbols for delimiters and ways to indicate units and arithmetic. For a measurement environment (say, electronics, optical, mechanical, biological, acoustical, chemical, musical, etc.) there are also various technical legends specific to the nature of the measurement appear as prefixes or suffixes, and often pertain to the notion of “units.” The notion of “units” includes both the kind of thing being measured (e.g., volts, ohms, acceleration, temperature, pitch, etc.) and its size or magnitude (e.g., volts, millivolts or micro-volts, kilo-newtons, degrees, and so on).

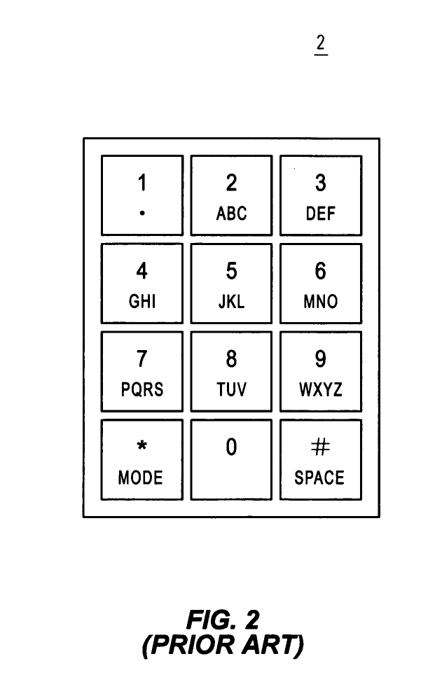

FIG. 2 shows a front view of a typical keypad 2 for a cellular telephone. A favorite way that text is entered using this keypad is called “multi-tap.” It entails rapidly and consecutively pressing a key the number of times needed to identify the position within the supplemental symbols of the intended symbol. The supplemental symbols on the ‘2’ key are A B C. Thus, two taps on the ‘2’ key will produce a ‘B’, and three taps on the ‘3’ key will conjure a ‘C’. The selection is cyclic, so a fourth tap will ‘wrap around’ to start again with ‘2’. One advantage of this scheme, beside being widely used on phones, is that it is perhaps simpler, in that one can keep his fingertip on the same key for the entry of any given symbol. On the other hand, there are special rules that must be appreciated. Two taps on the ‘star’ key do not produce an ‘M’, but they might cause a Mode change from one setting to another. The user must know or remember ahead of time that the string M-O-D-E on the ‘star’ key is not of the same category as, say, the W-X-Y-Z on the ‘9’ key. What is more, he has to appreciate the notion of whatever Mode is at issue (the word ‘MODE’ by itself doesn't say what that notion might entail . . . ). A similar irregularity attends the S-P-A-C-E on the ‘pound’ (#) key, except in this case ‘SPACE’ is the name of, and is the visible place holder for, a blank region that will be inserted into the result, and which is not well represented by a blank space on the key. (So, ‘SPACE’ as word is like the letter ‘X’ in W-X-Y-Z on the ‘9’ key . . . .) These are examples of minor potentials for category mistakes to be made by the unwary, and while not fatal, give us pause for attempting to use this particular layout/strategy in applications where we might be tempted to extend it to carry unfamiliar legends or abbreviations, perhaps of a technical nature, that might properly belong to the environment being controlled. Still, there might be some simple cases where its use as a text/command entry device would be expected (owing to previous experience), convenient and effective.

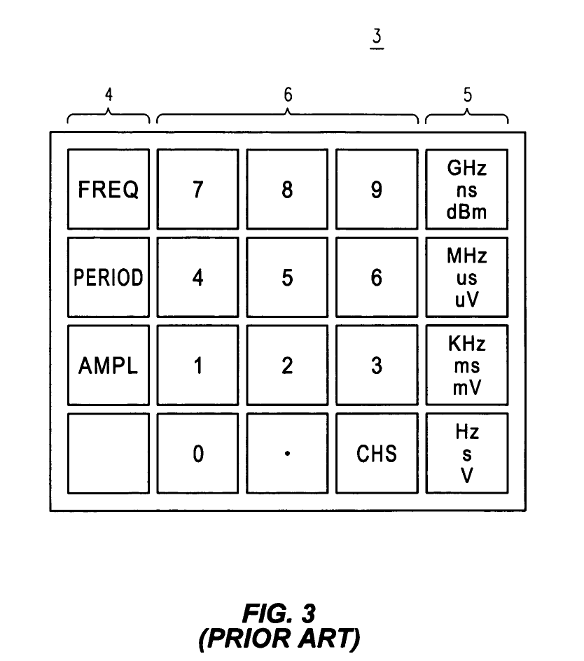

Now refer to FIG. 3. Here is shown a typical simple keypad 3 for an instrument that probably does not need text entry: there is no provision for it. What is provided is a column 4 of command keys (FREQ, PERIOD, AMPL, and another key), a column 5 of units keys and three columns 6 of digit keys and their associated ‘helpers’ (the decimal point and a CHS (Change Sign or ±) key that may toggle its meaning when pressed consecutively). Even though the units keys each have three meanings, which of the three is taken as the meaning is context sensitive within a predetermined syntax of <command> <digit> <digit> . . . <unit>. That is, the nature of the command selects the nature of the unit: voltage for amplitude, time for period and hertz for frequency. Even if we were to attempt to put a ‘shift/unshift’ key into the mix (and perhaps an “I am shifted indicator”), there are but nineteen remaining keys to carry shifted meanings, and that is not enough for the alphabet without also resorting to one of the techniques discussed in connection with FIGS. 1 and 2 (but, of course, to be applied only to the shifted meanings of those nineteen keys . . . .) That would be a rather complicated and confusing arrangement.

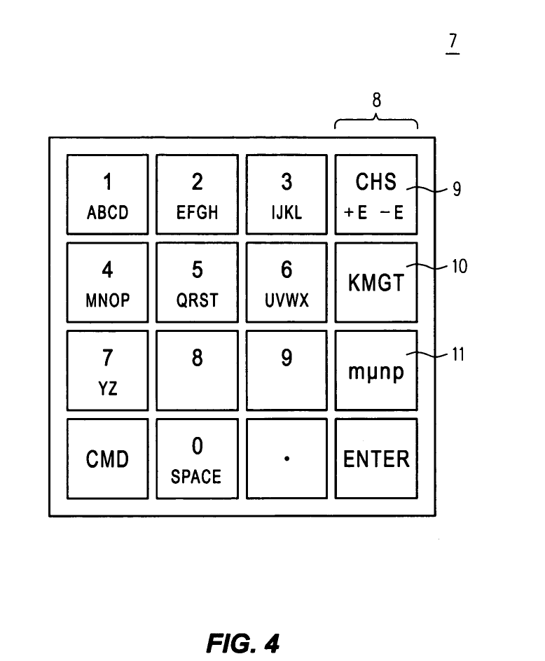

Now consider FIG. 4. Here we show a keypad the is similar to the conventional basic touch tone/cellular arrangement, but which has been augmented with a fourth column 8 of additional keys. In addition, what used to be the ‘star’ key is now a CMD key, while ‘0’ (zero) has acquired the supplemental meaning ‘space’ (a useful delimiter symbol), and what used to be the ‘pound’ (#) key is now just the decimal point. (We don't want it shared, especially not with a digit, so as to not interfere with the ability to enter <digit> <digit> <point> <digit> . . . .) It will be appreciated that out use of, and reference to, telephone keypads is merely exemplary, and that other number of keys, arrangements of rows and columns, and combinations of symbols or legends carried thereon, are possible. Furthermore, we are not concerned with the particular methods used to determine that a key is pressed, which key it is, or that more than one key is pressed. We are instead concerned with what might be called the ‘usage model.’

Keypad 7 may be used, in part, in a multi-tap fashion. We note the following. The CMD key (which might also be thought of as a MODE key) can be pressed repeatedly to bring into force operation in a next Mode of operation in a cyclic sequence of modes. The current Mode in force can be indicated by an annunciator legend on the case or that is part of a display. The list of Modes in the sequence can be much longer than corresponding legends that would fit on the key itself. The notion of ‘operate in a given mode’ can include a Text Entry Mode wherein a collection of just certain keys are to be construed as multi-tap as to the printed symbols they carry. That collection of keys can include all of the nominal digit keys and the decimal point. Let us call this a ‘Symbol’ Mode.

When the Symbol Mode is in effect (just as for shift) an associated annunciator can be displayed to assist the operator by advising him of which of the various Modes is in effect. In the Symbol Mode one tap on the ‘2’ would produce a ‘2’, two taps an ‘A’, three taps a ‘B’ and four a ‘2’. One tap on the ‘0’ key would produce a ‘0’ while two taps would beget a ‘SPACE’ (while yet a third would bring back the zero, and so on). This arrangement allows ‘text’ to include not only the alphabetic symbols, but also the digits (or other symbols on keys included in the arrangement). The ENTER key of the column 8 can be used to terminate or execute an entry.

It must not be assumed that using the CMD key is the only way to arrive within the Symbol Mode. There may well be commands or operations that are carried out by the instrument that solicit text or symbolic information during their execution. In such a case the Symbol Mode can be automatically entered at the appropriate time, the annunciator adjusted to reflect that, and then upon satisfaction of the Symbol Mode entry operation, the Symbol Mode is automatically terminated. For example, suppose the instrument had a wireless link to a plotting device, and some labeling strings were needed. An automatic transition into and out of the Symbol Mode could occur during the execution of a PLOT command.

When the non-Symbol Mode (which might be termed a Numeric Mode) is in effect the digit keys (and any other potential Symbol Mode keys) are not multi-tap. This allows for easy and rapid entry of numbers that have repeated digits.

On the other hand, the units keys (10, 11) and the sign key (9) in column 8 can or might always operate in the multi-tap mode. In this connection we note that the CHS +E −E key 9 is usable for sign inversion of a number, for beginning a positive exponent entry, or beginning a negative exponent entry. The units key 10 is good for metric unit prefixes greater than one (Kilo, Mega, Giga, Tera) while the units key 11 serves for prefixes less of values less than one (milli, micro, nano, pico). As an alternative, the two units keys 10 and 11 could be combined into one eight item cyclic multi-tap monster. It will be appreciated that there are several syntactic possibilities for things like exponent entry, and that our primary interest here is in the usage model for the external keypad. It is clear that corresponding properties of the parser or interpreter within, and that deal with what the execution of a completed sequence of entered symbols/legends/commands/digits/. . . actually means or does are ancillary issues readily implemented by those skilled in the art.

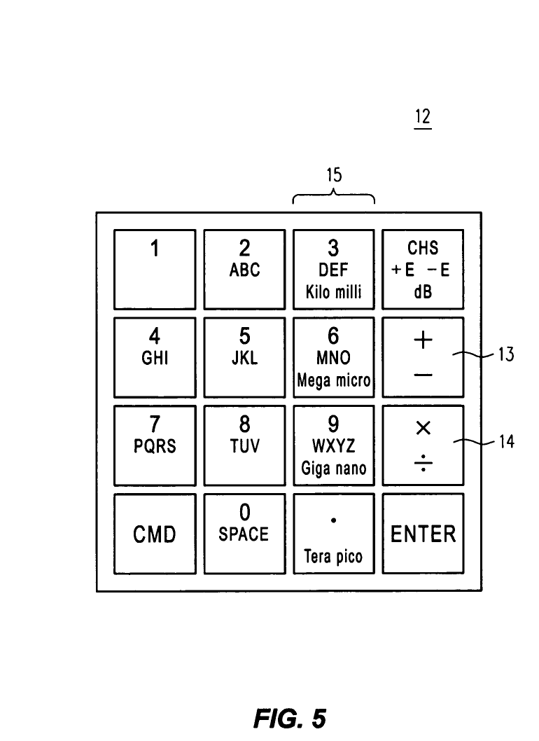

FIG. 5 shows a variation 12 on the arrangement 7 of FIG. 5. This variation 12 can be used to free up some keys (13, 14) for other uses (which we acknowledge might be anything—we choose to use them here for arithmetic keys). To accomplish this we move the metric prefix keys into the column 15 as complete unified multi-tap symbols (i.e., ‘Mega’ is one entire legend equivalent to the single symbol ‘M’).

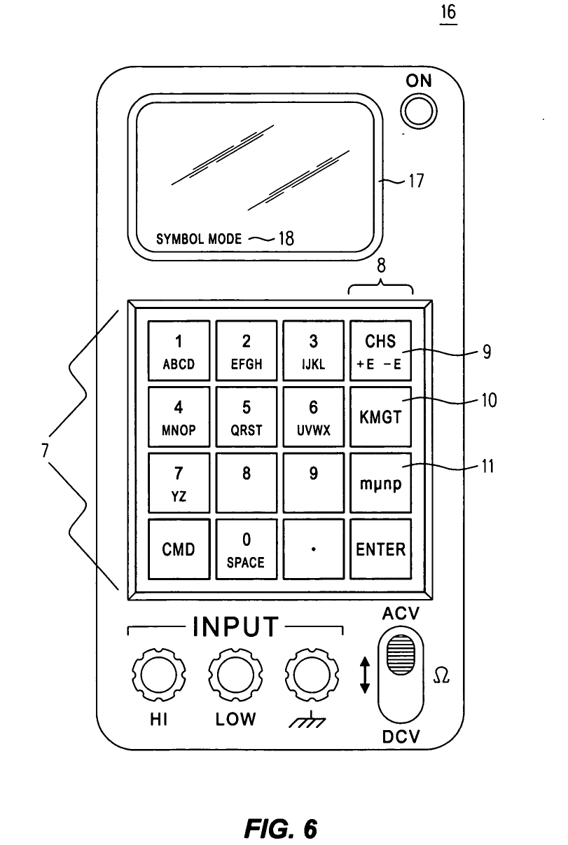

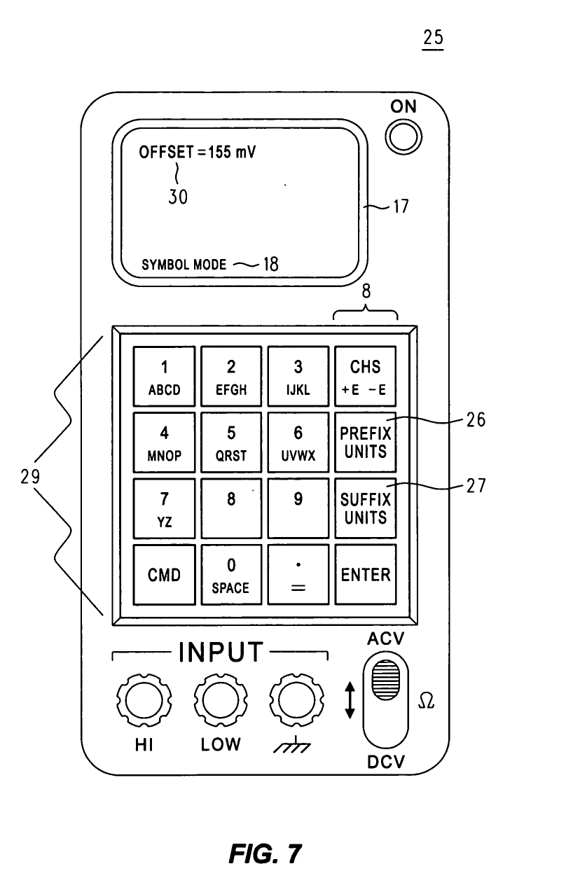

Refer now to FIGS. 6 through 9. FIG. 6 shows a fanciful ‘small’ electronic test instrument 16 that uses the augmented keyboard 7 of FIG. 4, and electronic instrument 25 of FIG. 7 is similar. We are not suggesting with these figures that there actually are such real instruments, only that there certainly could be. The exact nature of the instruments 16, 19, 20 and 25 is not important—they might be multi-meters, a source, some sort of ‘analyzer’ or whatever. Furthermore, the reader should not be misled by the fact that we have chosen ‘electronic test equipment’ as the subject area for the example fanciful items 16, 19, 20 and 25. To draw an actual figure we had to pick something, and most readers would probably be at least outwardly familiar with what we have shown. Once again, the particular discipline of for the example is not what is important. Furthermore, whether the ‘instrument’ is one that performs a measurement upon a signal applied to it, such as with meters or analyzers, or whether it is a source of a signal that it generates itself and that is then applied to some other environment, we shall be content to henceforth refer to it as an ‘instrument.’ What is of interest is that these instruments are complex enough to require a fairly extensive set of controls that take the form of commands created with a keyboard, and that the ability to enter text (possibly pertaining to a technical vocabulary) is necessary or highly desirable. Since these instruments are ‘small’ (perhaps handheld, and maybe even shirt pocket size) there is not room for a full size keyboard. (And, we choose not to attempt a folding version, with all of its mechanical considerations, and so on for other ersatz ‘full size keyboards.’) The solution is to use an augmented keypad similar in nature to those that are shown in FIGS. 4 and 5.

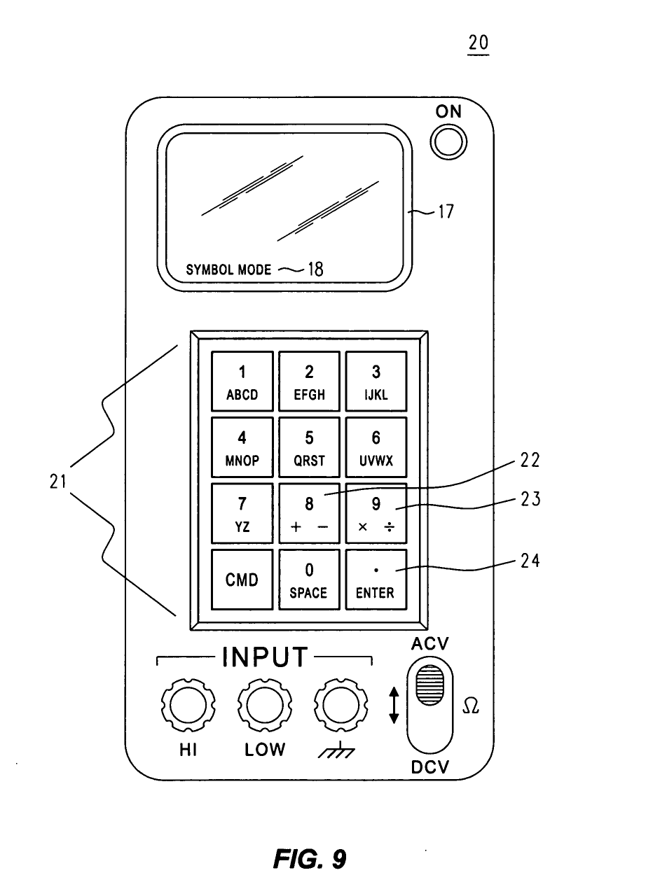

With respect to FIGS. 6 through 9, note that each of instruments 16 and 25 has a display 17. Now, the gory details of exactly what gets displayed, its syntax, and how much is visible, etc., are details that do not concern us, as we are not particularly interested in any one specific case. On the other hand, note the annunciator 18 for the Symbol Mode. The idea here is that it is visible (displayed, ON, etc.) when an activation of the CMD key has instituted the Symbol Mode for enabling the augmented meanings for the other keys, as previously described, or, when the execution of some command has automatically instituted the Symbol Mode. At other times the annunciator 18 will be OFF, or an alternate legend (e.g., NUMERIC MODE 28 as in FIG. 9) might be displayed. What is envisioned for FIGS. 6 and 7 is that the digit and decimal point keys constitute a first collection that operate in the Numeric Mode at times and in the symbol Mode during other times, as controlled automatically or by keystrokes of the CMD key and indicated by the annunciator(s) (18/28). The ENTER key is probably always just the ENTER key, while the keys 9, 10 and 11 always operate in the Text Mode that is associated with the Symbol Mode (e.g., multi-tap or T9Word). In the case of key 9, it will be appreciated from context that the legends +E and −E are each a ‘unit symbol’ in a logical sense, even though they are physically composed of ‘two things.’ For key 9, a first pressing complements an existing sign at the ‘current location,’ while a second keystroke undoes the complement sign operation and puts in a +E, and the third replaces the +E with a −E. A fourth keystroke issued before a delimiting time interval from the previous one will delete the −E and again complement the sign. On the other hand, and for the opposite sense of the same principle, KMGT legend on the key 10 will be readily spotted as being ‘really’ K-M-G and T, since that is suspiciously similar to Kilo, Mega, Giga and Tera, and this is, after all, an electronic measurement application with banana plug input terminals . . . . Thus, owing at least partly to this familiarity (or maybe he actually read the operating manual), the user will not be surprised that each successive individual ‘K’, ‘M’, ‘G’ or ‘T’ is entered into the display (each as a replacements for its predecessor) as the result of successive keystrokes before a time limit from the last keystroke kicks in and acts a delimiter of entry at that position. The situation with key 11 corresponds exactly to that of key 10, save that the legend mμnp represents the familiar ‘milli,’ ‘micro,’ ‘nano’ and ‘pico.’.

FIG. 7 illustrates a situation very similar to that of FIG. 6. The difference is that in keypad 29 key 26 is labeled PREFIX UNITS and key 27 is labeled SUFFIX UNITS. Despite a want of better terms, these will be appreciated as respectively referring to “size identifiers that go in front” and “type-of identifiers that go in back.” So, for the string 495 MHz, we would say that the ‘495’ is a numeric parameter, that the ‘M’ was a Prefix Unit, and that the ‘Hz’ was a Suffix Unit. This is generally agreeable, as electronic and other scientific and engineering disciplines are rife with legends, and it is useful to have them available. It will be noted, however, that the keys 26 and 27 do not themselves give any definite hint of what they really do (and we can assume for the moment that key 27 is to replace key 10). Here is what happens: it is as if the key 27 WERE carrying the legend KMGT !! That legend does not need to be on the key for successive keystrokes to do the multi-tap entry of the individual ‘K’, ‘M’, ‘G’ and ‘T.’ It only needs to be there to alert the operator ahead of time. If the operator were alert to what was being put into the display, then he could be ignorant of the exact order, and simply stop when the desired legend was shown in the display. Furthermore, the cyclic list might be one that is too long to fit on the key. So, for example, the list could actually be ‘K’, ‘M’, ‘G’, ‘T’, ‘m’, ‘μ’, ‘n’ and ‘p’. That (or a longer list!) may well be too long to fit on the key, but not so long as to offend the user, especially if the items were in a readily appreciated order, and perhaps also if there were some strategically included NULLs in the sequence and that are treated as null operations: ‘K’, ‘M’, ‘G’, ‘T’, <NULL>‘m’, ‘μ’, ‘n’ and ‘p’ <NULL>. This latter trick is to provide an easy escape for the user who has mistakenly pressed such a key and who can then put the null (perhaps displayed as a ‘zero length SPACE’—which is to say, as nothing!) ‘into’ the string to mean “forget I pressed this key—I didn't mean to do it . . . ”. If desired, the NULL could be shown as an agreeable visible symbol meaning “NO-OP” (for No Operation). (# and % come to mind, but they might also be somebody's favorite for something else. A solid square would get the message across, too.) We note that a visible NULL symbol would not need to be shown as a legend on the keys (but if it were, no harm would arise), although it might be useful to show it and its meaning on the case (perhaps on the back, along with some condensed user's general instructions, or on a pull-out card).

There is a similarity between how keys 26 and 27 are to operate and how the CMD key has been described. In each case there is a ‘hidden’ list of actions/entries that are sequentially invoked. (That is, ‘hidden’ in the sense that the list is not shown as a legend on the key.) The difference is that, for the CMD key the action is immediate, is a ‘meta action’ that establishes a ‘mode’ in which the operation of other keys is affected, and perhaps the nature of the meta action is shown in a dedicated annunciator (18, 28). On the other hand, keys such as 26 and 27 place their selected result (probably via multi-tap) into a ‘next location’ in string being created and which is probably executed or invoked only after it is fully formed.

Before leaving FIG. 7, notice the entry 30 in the display 17. Here is one sequence of keystrokes on keypad 29 that could produce the string OFFSET=155 mV:

<CMD> <4> <4> <4> <4> <2> <2> <2 > [pause] <2> <2 > <2> <5>
<5> <5> <5> < 2> < 2> <.> < .> <CMD> <1> <5> <5>
<SUFFIX UNITS > <SUFFIX UNITS> <SUFFIX UNITS> <SUFFIX
UNITS> <SUFFIX UNITS> <SUFFIX UNITS> <PREFIX UNITS>

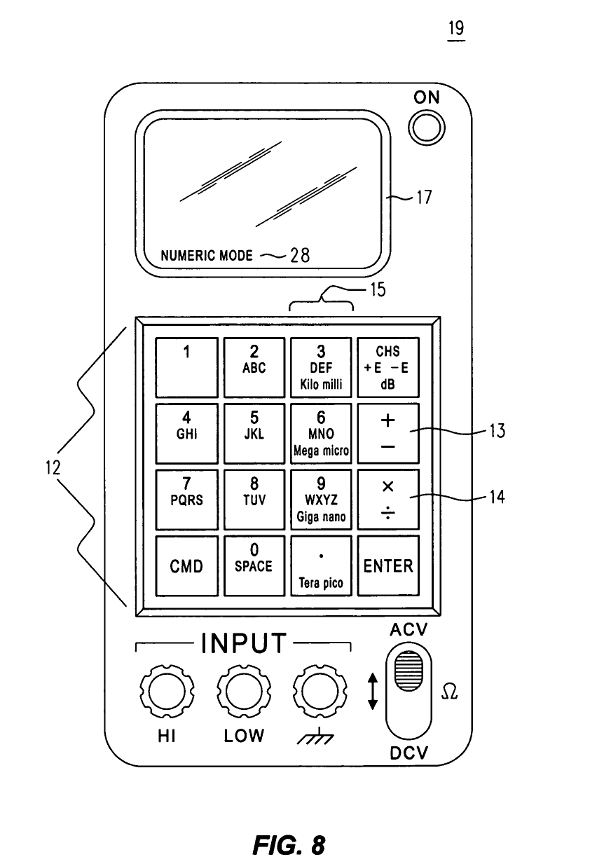

FIG. 8 shows a similar fanciful ‘small’ electronic test instrument 19 that uses the augmented keyboard 12 of FIG. 5. Note that the annunciator 28 is the legend NUMERIC MODE. It will likewise by now be appreciated that the keys in column 15 have readily appreciated meanings for the Symbol Mode. In particular, six successive presses of the “3” key will cycle through the entries for ‘3’, ‘D’, ‘E’, ‘F’, ‘K’ (or ‘Kilo’) and ‘m’ (or ‘milli’). If desired, the embedded “NULL” trick could used here, too, to avoid the need for a BACKSPACE key.

FIG. 9 shows a fanciful ‘small’ electronic test instrument 20 that uses an augmented keyboard 21 that is a hybrid of the ones shown in FIGS. 1 and 4. Although we have shown an illustrative particular secondary or augmented meanings for key 22 (+, −) and for key 23 (×, ÷), it will be appreciated that exactly what these might be in some other embodiment is contingent upon that specific situation. The same may be said for the secondary meaning for ‘ENTER’ on key 24. What we can observe from FIG. 9 is that the keypad 21 is truly a minimalist solution, and might rely heavily upon the CMD key to easily and conveniently switch between a Symbol Mode and a Numeric (entry) Mode.

As a concluding remark, it will be noted that the keypads themselves that we have shown do not include any ‘housekeeping’ functions that might ordinarily be expected to be present in an environment that performs entry of alphabetic text or, for that matter, numeric values. People do make mistakes, and cursor control (‘ARROW’) keys for non-destructively moving a cursor (say, two keys for ‘left and ‘right’, or four for ‘left’, ‘right’, ‘up’ and ‘down’), a BACKSPACE key and a CLEAR key are part of the usual kit and caboodle found in such systems. We have not shown such conventional keys, and by their absence we are NOT saying that they should not be there. Rather, and since there is a wide variety of how those functions are implemented, and since they are only ancillary to the main augmented keyboard function of specifying how a large number of symbols, technical legends and digits are to be entered using a small number of keys, we have elected not to show such housekeeping keys as part of the keypads of FIGS. 4 and 5, or as separate keys in FIGS. 6-9. However, we have no doubt that they would probably be there to assist operators in the correction of errors and for otherwise editing the input.

I claim:

1. An instrument responsive to both alphabetic input and numeric input, the instrument comprising:
a case;
a terminal at which a work signal appears;
a keypad disposed on the case and having a first collection of keys that includes a separate key for each of the digits zero through nine and the decimal point, at least one of the keys in the first collection having an alternate legend of at least one symbol thereon in addition to a digit or a decimal point;
a key separate from the first collection whose effect is to switch between a numeric mode wherein keystrokes for keys in the first collection cause entry of the respectively associated digit or the decimal point, and a symbol mode wherein keystrokes for keys in the first collection cause the entry, in accordance with the number of times a keystroke is repeated, of an individual symbol drawn from within an ordering of the union of the numeric mode digit or decimal point on the key with the symbol mode alternate legend as it appears on the key;
a display disposed upon the case and that displays indicia indicative of keystrokes in the numeric and symbol modes, and that displays information pertaining to the work signal appearing at the terminal in accordance with keystrokes performed in at least one of the numeric and symbol modes.

2. An instrument as in claim 1 further comprising an annunciator that indicates when one of the numeric and symbol modes is in effect.

3. An instrument as in claim 1 wherein the keypad has a second collection of keys, at least one key in the second collection bearing at least one technical legend corresponding to an alternate meaning that is selected in accordance with a number of times the at least one key in the second collection is repeatedly pressed, and wherein an abbreviation representing the selected alternate meaning is entered in response to keystrokes for the at least one key in the second collection.

4. An instrument as in claim 3 wherein the at least one technical legend is related to the measurement by the instrument of a signal applied to the terminal.

5. An instrument as in claim 3 wherein the at least one technical legend is related to the generation of a signal by the instrument and produced at the terminal.

6. An instrument responsive to both alphabetic input and numeric input, the instrument comprising:
a case;
an input terminal at which a work signal appears;
a keypad disposed on the case and having a first collection of keys that includes a separate key for each of the digits zero through nine and the decimal point, at least one key in the first collection having an alternate legend of at least one symbol thereon in addition to a digit or a decimal point;
a key separate from the first collection whose effect is to switch between a numeric mode wherein keystrokes for keys in the first collection cause entry of the respectively associated digit or the decimal point, and a symbol mode wherein keystrokes for the at least one key in the first collection cause the entry of one or more symbols representing a different alternate meaning of the at least one key in the first collection, according to the number of consecutive keystrokes for that at least one key and in accordance with successive locations in a circular list of the alternate meanings;
a display disposed upon the case and that displays indicia indicative of keystrokes in the numeric and symbol modes, and that displays results for a signal applied to the input terminal and measured in accordance with keystrokes performed in at least one of the numeric and symbol modes.

7. An instrument as in claim 6 wherein the entered symbols representing alternate meanings correspond to, but are different from, indicia on the at least one key.

8. An instrument as in claim 6 wherein the entered symbols representing alternate meanings lack a list of corresponding indicia on the at least one key.

9. An instrument as in claim 6 wherein further comprising an annunciator that indicates when one of the numeric and symbol modes is in effect.

10. An instrument as in claim 6 wherein the keypad has a second collection of keys, at least one key in the second collection bearing at least one technical legend corresponding to an alternate meaning that is selected in accordance with a number of times the at least one key in the second collection is repeatedly pressed, and wherein an abbreviation representing the selected alternate meaning is entered in response to keystrokes for the at least one key in the second collection.

11. An instrument as in claim 10 wherein the at least one technical legend is related to the measurement by the instrument of a signal applied to the terminal.

12. An instrument as in claim 10 wherein the at least one technical legend is related to the generation of a signal by the instrument and produced at the terminal.

13. An instrument responsive to both alphabetic input and numeric input, the instrument comprising:
a case;
an input terminal at which a work signal appears;
a keypad disposed on the case and having a first collection of keys that includes a separate key for each of the digits zero through nine and the decimal point, at least one of the keys in the first collection having an alternate legend of at least one symbol thereon in addition to a digit or a decimal point;
a key separate from the first collection whose effect is to switch between a numeric mode wherein keystrokes for keys in the first collection cause entry of the respectively associated digit or the decimal point, and a symbol mode wherein keystrokes for keys in the first collection cause the entry, in accordance with a comparison to preselected possibilities, of respective alternate partial spellings that may be formed from the individual symbols that appear in legends of the keys in the first collection that have been pressed in a sequence of keystrokes;
a display disposed upon the case and that displays indicia indicative of keystrokes in the numeric and symbol modes, and that displays information pertaining to the work signal appearing at the input terminal in accordance with keystrokes performed in at least one of the numeric and symbol modes.

14. An instrument as in claim 13 further comprising an annunciator that indicates when one of the numeric and symbol modes is in effect.

15. An instrument as in claim 13 wherein the keypad has a second collection of keys, at least one key in the second collection bearing at least one technical legend corresponding to an alternate meaning that is selected in accordance with a number of times the at least one key in the second collection is repeatedly pressed, and wherein an abbreviation representing the selected alternate meaning is entered in response to keystrokes for the at least one key in the second collection.

16. An instrument as in claim 15 wherein the at least one technical legend is related to the measurement by the instrument of a signal applied to the terminal.

17. An instrument as in claim 15 wherein the at least one technical legend is related to the generation of a signal by the instrument and produced at the terminal.

18. A method of entering both text and numeric input into an instrument having a keyboard with a separate key for each of the digits zero through nine and the decimal point, each of which separate keys bears a respective primary legend of zero through nine and the decimal point, and where at least one key on the keyboard bears at least one alternate legend of at least one text symbol different from any primary legend, the method comprising the steps of:
(a) entering numeric input by placing into a displayed input string during a numeric mode an instance of the primary legend associated with a key each time that key is pressed;
(b) instructing the instrument to execute a command;
(c) automatically entering a symbol mode during the execution of the command;
(d) while in the symbol mode, entering text by placing into the displayed input string text symbols corresponding to an alternate legend upon the at least one key according to instances of pressing that at least one key;
(e) signaling the end of the text entered in step (d); and
(f) subsequent to steps (b), (c) (d) and (e), automatically re-entering the numeric mode.

19. A method as in claim 18 further comprising the step of controlling an annunciator that indicates when one of the numeric and symbol modes is in effect.
